(19) United States
(12) Patent Application Publication
(10) Pub. No.: US 2026/0075662 A1
(43) Pub. Date: Mar. 12, 2026

(54) DS MAC COLLISION AVOIDANCE

(71) Applicant: Cisco Technology, Inc., San Jose, CA (US)

(72) Inventors: Jerome HENRY, Pittsboro, NC (US); Domenico FICARA, Essertines-Sur-Yverdon (CH); Ugo M. CAMPIGLIO, Morges (CH); Javier I. CONTRERAS ALBESA, Sant Cugat del Valles (ES)

(21) Appl. No.: 19/281,591

(22) Filed: Jul. 26, 2025

Related U.S. Application Data
(60) Provisional application No. 63/691,606, filed on Sep. 6, 2024.

(51) Int. Cl. H04W 76/10; H04W 12/02; H04W 60/04; H04W 88/08

(52) U.S. Cl. CPC H04W 76/10; H04W 12/02; H04W 60/04; H04W 88/08

(57) ABSTRACT

Aspects of the disclosure provide a method including establishing a wireless communications link between a first access point and a wireless station, and receiving a first wireless frame on the wireless communications link. The first wireless frame includes a requested media access control (MAC) address for use by the wireless station within a distribution system (DS) providing infrastructure that connects a plurality of access points including the first access point. The method further includes determining whether the requested MAC address is in use by another wireless station connected to one of the plurality of access points, and transmitting a second wireless frame on the wireless communications link. The second wireless frame includes an indication, based at least in part on whether the requested MAC address is in use, whether use of the requested MAC address by the wireless station is approved.

### CROSS-REFERENCE TO RELATED APPLICATIONS

This application claims benefit of co-pending United States provisional patent application Serial No. 63/691,606 filed September 6, 2024. The aforementioned related patent application is herein incorporated by reference in its entirety.

### TECHNICAL FIELD

Embodiments presented in this disclosure generally relate to wireless communication. More specifically, embodiments disclosed herein relate to the use of Distribution System Media Access Control (DS MAC) addresses to identify wireless stations (STAs) in wireless communication networks.

### BACKGROUND

Wireless communication networks, such as Wi-Fi, rely on various identifiers to manage device activities and facilitate communication between access points (APs) and STAs. However, the reuse of these identifiers can be exploited to track devices, monitor user activity, and conduct privacy-invasive operations. By collecting and analyzing these identifiers over time, a device’s current network activity may be linked to its past network activity. Attackers can collect and analyze these identifiers over time, correlating a device’s previous network activity with its present network activity. Some examples of identifiers that are susceptible to being tracked include MAC addresses, association identifiers (AIDs), and sequence numbers in frame headers.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 depicts an example Association Response frame including a DS MAC status field, according to some embodiments of the present disclosure.

FIG. 2 depicts an example method of coordinating assignment of a DS MAC address to a wireless station using an Association Response frame, according to some embodiments of the present disclosure.

FIG. 3 depicts an example method of coordinating assignment of a DS MAC address to a wireless station using a DS MAC action frame, according to some embodiments of the present disclosure.

FIG. 4 depicts an example network device configured to perform various aspects of the present disclosure, according to some aspects of the present disclosure.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### OVERVIEW

One embodiment presented in this disclosure provides a method including establishing a wireless communications link between a first access point and a wireless station, and receiving a first wireless frame on the wireless communications link. The first wireless frame includes a requested media access control (MAC) address for use by the wireless station within a distribution system (DS) providing infrastructure that connects a plurality of access points including the first access point. The method further includes determining whether the requested MAC address is in use by another wireless station connected to one of the plurality of access points, and transmitting a second wireless frame on the wireless communications link. The second wireless frame includes an indication, based at least in part on whether the requested MAC address is in use, whether use of the requested MAC address by the wireless station is approved.

Another embodiment presented in this disclosure provides an access point including one or more processors and memory configured to store computer-readable program code which, when executed by any combination of the one or more processors, performs an operation that includes establishing a wireless communications link between the access point and a wireless station. The operation further includes receiving a first wireless frame on the wireless communications link. The first wireless frame includes a requested media access control (MAC) address for use by the wireless station within a distribution system (DS) providing infrastructure that connects a plurality of access points including the access point. The operation further includes determining whether the requested MAC address is in use by another wireless station connected to one of the plurality of access points, and transmitting a second wireless frame on the wireless communications link. The second wireless frame includes an indication, based at least in part on whether the requested MAC address is in use, whether use of the requested MAC address by the wireless station is approved.

Another embodiment presented in this disclosure provides a non-transitory computer-readable storage medium including instructions that when executed configure one or more processors of an access point (AP) to perform operations including establishing a wireless communications link between the access point and a wireless station, and receiving a first wireless frame on the wireless communications link. The first wireless frame includes a requested media access control (MAC) address for use by the wireless station within a distribution system (DS) providing infrastructure that connects a plurality of access points including the access point. The operations further include determining whether the requested MAC address is in use by another wireless station connected to one of the plurality of access points, and transmitting a second wireless frame on the wireless communications link. The second wireless frame includes an indication, based at least in part on whether the requested MAC address is in use, whether use of the requested MAC address by the wireless station is approved.

### EXAMPLE EMBODIMENTS

Enhanced Data Privacy (EDP) has been introduced to prevent attackers from tracking devices based on fixed identifiers commonly used in wireless communication networks. EDP involves dynamically updating identifiers at defined epochs to anonymize the device’s identity. Such periodic changes improve privacy by making it difficult for an attacker to correlate a device’s presence and activity across different time intervals. Common identifiers that are susceptible to being tracked include the MAC address, AID, sequence numbers in frame headers, and other protocol-specific identifiers that are used across multiple transmissions.

The DS provides infrastructure that connects multiple APs within a wireless communication network, and may further connect with a wired network. As the same privacy concerns may not be present for communications within the DS, the MAC address that is used to identify the STA need not be randomized or otherwise obscured. Each STA may use a DS MAC address that allows the AP to maintain identity-aware services, such as session continuity, access control and policy enforcement, seamless roaming and fast transitions, and credentialed access. Without the use of the DS MAC address, these services may be ineffective or may require complex workarounds, especially in enterprise or managed networks.

Within the IEEE 802.11bi standard, the DS MAC field is included as an information element within an encrypted Associated Request frame. Because this field is merely informational, conventional implementations of the AP are unable to negotiate the DS MAC address that has been specified by the STA. However, it is possible that the specified DS MAC address may be invalid, or may conflict with the DS MAC address of another STA connected with the DS through the same or another AP.

Embodiments of the present disclosure provide systems, methods, and apparatuses for negotiating and/or validating DS MAC addresses for devices in wireless communication networks. In some embodiments, a method includes establishing a wireless communications link between a first AP and a STA. The method further includes receiving a first wireless frame on the wireless communications link, where the first wireless frame includes a requested MAC address for use by the STA within a DS providing infrastructure that connects a plurality of APs including the first AP. The method further includes determining whether the requested MAC address is in use by another STA connected to one of the plurality of APs. The method further includes transmitting a second wireless frame on the wireless communications link, the second wireless frame including an indication, based at least in part on whether the requested MAC address is in use, whether use of the requested MAC address by the wireless station is approved.

The requested MAC address may be a hardware-based MAC address of the STA, or may be another MAC address that is generated or otherwise selected by the STA. The second wireless frame may have any suitable formatting, such as an Association Response frame or a DS MAC action frame. In some embodiments, the second wireless frame includes a discrete DS MAC status field, and the indication is a value in the DS MAC status field. In some embodiments, the second wireless frame further includes a proposed DS MAC address for the wireless station. In determining the proposed DS MAC address, the AP may verify that the proposed DS MAC address is not being used by another device on the DS, e.g., by accessing its local MAC address table or by querying a device connected to the DS (such as a wireless local area network controller (WLC)).

As discussed above, using the DS MAC address allows the AP to maintain various identity-aware services for the STA. Beneficially, the techniques described herein enable the AP to remedy any malformed DS MAC values that are requested by the STA, as well as preventing collisions with other devices using the same DS MAC value.

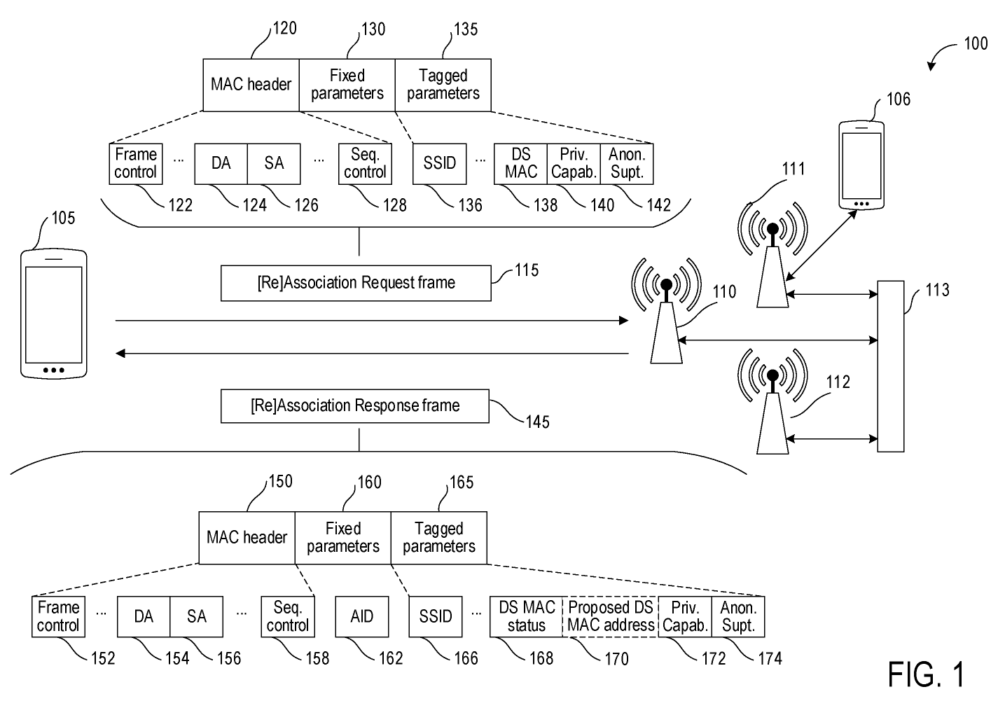

FIG. 1 depicts an example Association Response frame including a DS MAC status field, according to some embodiments of the present disclosure. In the wireless communications network 100, three (3) APs 110, 111, 112 are depicted, each connected to a DS 113. A first STA 105 is connected to the AP 110, and a second STA 106 is connected to the AP 111. Although three (3) APs 110, 111, 112 and two (2) STAs 105, 106 are depicted, any suitable numbers of APs and STAs are contemplated in the wireless communications network 100.

Each of the APs 110, 111, 112 may refer to an AP multi-link device (MLD), a single-link AP, or any other type of wireless network device capable of negotiating and/or validating DS MAC addresses for the STAs within a Basic Service Set (BSS). Each of the STAs 105, 106 may refer to a non-AP MLD, a single-link device, or another type of wireless station capable of establishing a connection with one of the APs 110, 111, 112.

The DS 113 comprises infrastructure that interconnects the plurality of APs 110, 111, 112 to support communications between devices of multiple BSSes and optionally with external networks. In some embodiments, the DS 113 is implemented using a wired Ethernet-based local area network (LAN), although other implementations of the DS 113 may include a wireless distribution system (WDS) or fiber optic-based implementation.

In some embodiments, the DS 113 defines a portal that acts as a logical bridge between the 802.11-based wireless communications network 100 and an external non-802.11 LAN. Through the portal, data can flow between the STAs 105, 106 and devices connected to the external network, such as servers, printers, or internet gateways. Within the wireless communications network 100, the APs 110, 111, 112 act as intermediaries between their associated STAs and the DS 113. Wireless frames received from a STA that are destined for other network entity (or entities) are forwarded by the corresponding AP 110, 111, 112 to the DS 113, which routes the frames to the appropriate destination(s), whether another one of the APs 110, 111, 112, a wired device connected to the DS 113, or the portal.

The DS 113 provides mobility support within the wireless communications network 100. When a STA is moved and transitions between the coverage areas of the APs 110, 111, 112, the DS 113 coordinates the reassociation process to ensure that wireless frames are delivered to the correct APs 110, 111, 112 without interruption. The ability of a STA to roam between different APs 110, 111, 112 of the same Extended Service Set (ESS) without dropping the connection is a defining feature of infrastructure mode networks that are made possible by the DS 113.

When requesting access to the wireless communications network 100, the STA 105 transmits an Authentication Request frame to the AP 110, which typically includes the MAC address of the STA 105, an authentication algorithm number, a transaction sequence number, and a status code. The AP 110 responds by transmitting an Authentication Response frame to the STA 105 that repeats several of the same values, but indicates the approval or denial of the STA’s request through the value of its status code.

After the STA 105 has been authenticated, the STA 105 transmits an Association Request frame 115 to the AP 110. The AP 110 parses the fields of the Association Request frame 115 to determine whether to accept the association with the STA 105 and how to configure the connection. The Association Request frame 115 begins with a MAC header 120 that includes several fields identifying the nature of the transmission and the involved devices. The Frame Control field 122 indicates that the particular frame is a management frame of the subtype “Association Request”. The Destination Address (DA) field 124 is set to the MAC address of the AP 110, and the Source Address (SA) field 126 is the MAC address that the STA 105 is currently using. In some cases, the STA 105 may be employing anonymization techniques, and the value of the SA field 126 may be a randomized MAC address. The Sequence Control field 128 provides a sequence number that helps in identifying and reassembling wireless frames. Although not shown, the MAC header 120 may include other fields, such as a Duration/ID field, a BSSID field, and so forth.

The Association Request frame 115 further includes several fixed parameters 130 following the MAC header 120, such as a Capability Information field describing the features supported by the STA 105, and a Listen Interval field that indicates how often the STA 105 wakes up to listen for beacon frames when in power-saving mode.

The Association Request frame 115 further includes several tagged parameters 135 following the fixed parameters 130. The tagged parameters 135 represent variable-length Information Elements (IEs) that provide a more detailed description of the capabilities and preferences of the STA 105. As shown, the tagged parameters 135 include a Service Set Identification (SSID) IE 136 containing the name of the network the STA 105 intends to join.

In cases where the STA 105 is configured to use MAC address randomization for increased privacy (e.g., as its identifier in the SA field 126), the tagged parameters 135 further include a DS MAC IE 138. In some embodiments, the DS MAC address is the permanent (e.g., hardware-based) MAC address of the STA 105. In other embodiments, the STA 105 selects the DS MAC address according to any suitable techniques. As mentioned above, use of the DS MAC address allows the AP 110 to recognize the STA 105 across multiple sessions and/or to maintain various identity-aware services for the STA 105.

In some embodiments, the tagged parameters 135 further include a Privacy Capability IE 140 that indicates the STA’s 105 support for anonymized identifiers or a preference for privacy-preserving operation, and an Anonymization Support IE 142 that indicates which anonymization schemes the STA 105 uses or supports, such as per-session or per-network MAC rotation. The Privacy Capability IE 140 and the Anonymization Support IE 142 configure the AP 110 to respond to the Association Request frame 115, e.g., whether to accept the association under anonymized conditions, whether to expect the true identity of the STA 105 in the DS MAC IE 138, or whether additional authentication or provisioning is needed. Although not shown, the tagged parameters 135 may include other fields, such as a Supported Rates IE, an Extended Supported Rates IE, a High Throughput (HT) Capabilities IE or a Very High Throughput (VHT) Capabilities IE, and/or a Robust Security Network IE.

After processing the Association Request frame 115, the AP 110 transmits an Association Response frame 145 to the STA 105 that indicates whether the association attempt has been accepted and, if so, under what conditions. The Association Response frame 145 begins with a MAC header 150, which includes a Frame Control field 152 that indicates that the particular frame is a management frame of the subtype "Association Response". The DA field 154 is set to the MAC address that is used by the STA 105 in the Association Request frame 115 (e.g., corresponding to the SA field 126), which may be a randomized MAC address. The SA field 156 is set to the MAC address of the AP 110. The Sequence Control field 158 includes a sequence number. Although not shown, the MAC header 120 may include other fields, such as a Duration/ID field, a BSSID field (which may be set to the MAC address of the AP), and so forth.

The Association Response frame 145 further includes several fixed parameters 160 following the MAC header 150. The fixed parameters 160 includes an Association ID (AID) field 162, which contains a value (typically 14 bits) assigned by the AP 110 to the STA 105. The AID field 162 is used by the AP 110 to uniquely identify the STA 105 within the BSS and to manage buffered traffic for the STA 105. In some embodiments, the AID value is rotated periodically by the (e.g., at epoch intervals) to improve the privacy of the STA 105. Although not shown, the fixed parameters 160 may include other fields, such as a Capability Information field and a Status Code field that informs the STA 105 whether the association request was successful or not.

The Association Response frame 145 further includes several tagged parameters 165 following the fixed parameters 160, which as shown include a SSID IE 166, a Privacy Capability IE 172, and an Anonymization Support IE 174.

The value of the DS MAC IE 138 that is unilaterally specified by the STA 105 may be invalid, or may conflict with a DS MAC address that is already in use by another STA within the wireless communications network 100. According to various embodiments, the Association Response frame 145 includes an indication, based at least in part on whether the MAC address requested by the STA 105 (that is, the value of the DS MAC IE 138) is in use, whether use of the requested MAC address by the STA 105 is approved. In some embodiments, the indication is further based on formatting of the value of the DS MAC IE 138.

In some embodiments, the Association Response frame 145 includes a discrete field whose value provides the indication. As shown, the tagged parameters 165 further include a DS MAC status field 168. The indication may be provided in any suitable format: a binary “yes” or “no”, a code indicating the reason for the disapproval of the requested MAC address, and so forth.

In some embodiments, the Association Response frame 145 further includes a Proposed DS MAC address field 170 for the STA 105. In some cases, the proposed DS MAC address field 170 is provided only where the DS MAC status field 168 indicates a disapproval of the requested MAC address. The AP 110 may determine the address in the proposed DS MAC address field 170 by verifying that the address is not being used by another device on the DS 113, e.g., by accessing its local MAC address table, by querying a device connected to the DS 113, and so forth.

In one alternate embodiment, the tagged parameters 165 may include a DS MAC address field in which the DS MAC address requested by the STA 105 is returned to indicate approval of the request, and the proposed DS MAC address is returned to indicate disapproval of the request. Other implementations for communicating the proposed DS MAC address are also contemplated.

After processing the Association Response frame 145, the STA 105 may proceed to complete any required authentication or key exchange steps with the AP 110, such as EAP or 4-way handshake. In some embodiments, the STA 105 acquiesces to (or accepts) using the DS MAC address proposed by the AP 110. In this case, the STA 105 may begin routine operation within the BSS. In another case where the STA 105 does not acquiesce to using the proposed DS MAC address, the STA 105 may transmit another wireless frame, such as a Reassociation Request frame that is largely similar to the Association Request frame 115, in which the DS MAC IE 138 includes a value different than the requested MAC address (by the STA 105) and the proposed MAC address (by the AP 110). In response, the AP 110 may transmit a Reassociation Response frame that is largely similar to the Association Response frame 145, in which approval or disapproval of the new value of the requested MAC address is indicated.

In some alternate embodiments, after completion of the association process with the AP 110, the STA 105 may transmit another type of wireless frame (e.g., a DS MAC action frame) that requests assignment of a DS MAC value. The DS MAC action frame may include a DS MAC IE 138 similar to the Association Request frame 115. The DS MAC action frame may include any additional information, such as a previous (or previously requested) DS MAC value that helps the AP 110 identify the requesting STA 105, a token value that identifies the dialog for retries, and the STA 105 sending the DS MAC value will likely be the same as the MAC value that was used to send the first, rejected DS MAC value. The AP 110 may transmit a response as an action frame that includes the DS MAC status field 168 and/or the Proposed DS MAC address field 170.

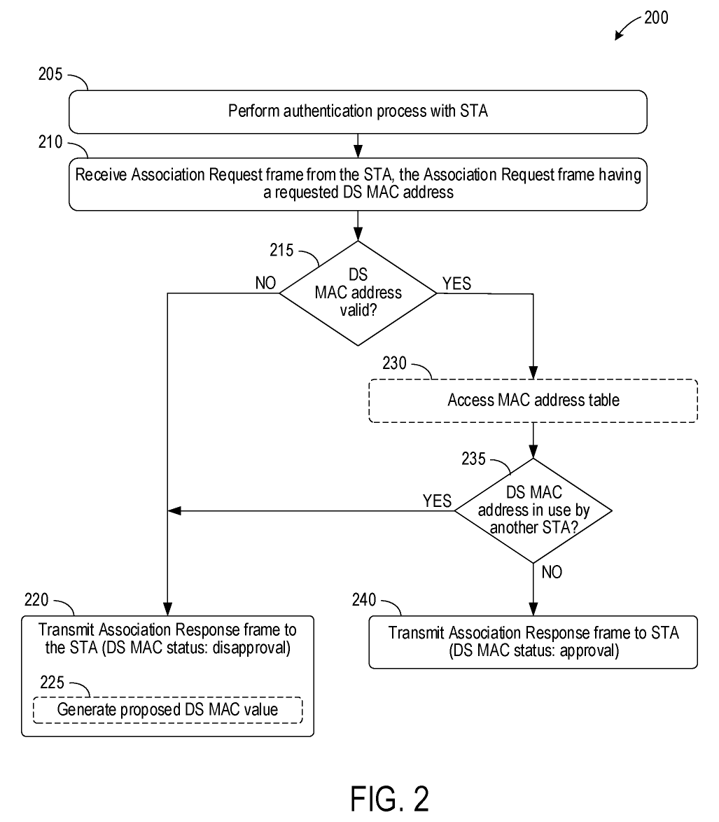

FIG. 2 depicts an example method 200 of coordinating assignment of a DS MAC address to a wireless station using an Association Response frame, according to some embodiments of the present disclosure. The method 200 may be used in conjunction with other embodiments, such as being performed by the AP 110 of the wireless communications network 100 of FIG. 1.

The method 200 begins at block 205, where the AP 110 performs an authentication process with the STA 105. In some embodiments, performing the authentication process comprises receiving an Authentication Request frame and transmitting an Authentication Response frame to the STA 105.

At block 210, the AP 110 receives an Association Request frame 115 from the STA 105. The Association Request frame 115 includes a requested DS MAC address for use by the STA 105 within the DS 113, which may be the hardware-based MAC address of the STA 105 or a DS MAC address that is selected by the STA 105.

Blocks 205, 210 may be encompassed by a process in which the AP 110 establishes a wireless communications link with the STA 105. In some embodiments, establishing the wireless communications link comprises assigning the STA 105 to an Enhanced Data Privacy (EDP) group that is associated with timing information for rotating wireless frame anonymization parameters (such as over-the-air MAC addresses and/or over-the-air AID values) at epoch transitions. EDP seeks to prevent attackers from tracking devices based on fixed identifiers commonly used in wireless communication networks, and involves dynamically updating identifiers at defined epochs to anonymize the identity of the STA 105. Such periodic changes improve privacy by making it difficult for an attacker to correlate a device’s presence across different time intervals.

At block 215, the AP 110 determines whether the requested DS MAC address is valid, e.g., performing processing to determine whether the requested DS MAC address is malformed or otherwise invalid. If the requested DS MAC address is not valid (“NO”), flow proceeds to block 220 and the AP 110 transmits an Association Response frame 145 to the STA 105 that indicates the disapproval of the requested DS MAC address. In some embodiments, the Association Response frame 145 includes a discrete DS MAC status field 168 whose value provides the indication of approval or disapproval, and optionally (at block 225) includes a proposed DS MAC address that is generated by the AP 110.

If the requested DS MAC address is valid (“YES”), flow proceeds to an optional block 230 and the AP 110 accesses a MAC address table (e.g., in its content-addressable memory). At block 235, the AP 110 determines whether the requested DS MAC address is in use by another STA in the DS 113. In some embodiments, this determination is based on the addresses stored in the MAC address table. In some embodiments, this determination is (further) based on querying a device connected to the DS 113, such as a WLC, whether the requested DS MAC address is available. The determination may be made with the functions overlapping in time (e.g., the AP 110 accesses the MAC address table and queries the device) or non-overlapping (e.g., the AP 110 first accesses the MAC address table first, and finding no conflict with the requested DS MAC address, queries the device). If the requested DS MAC address is in use by another STA (“YES”), flow proceeds to the block 220 and the AP 110 transmits an Association Response frame 145 that indicates the disapproval and optionally a proposed DS MAC address that is generated by the AP 110.

If the requested DS MAC address is not in use by another STA (“NO”), flow proceeds from block 235 to block 240 and the AP 110 transmits an Association Response frame 145 that indicates approval of the requested DS MAC address. The method 200 ends following completion of block 220 or block 240.

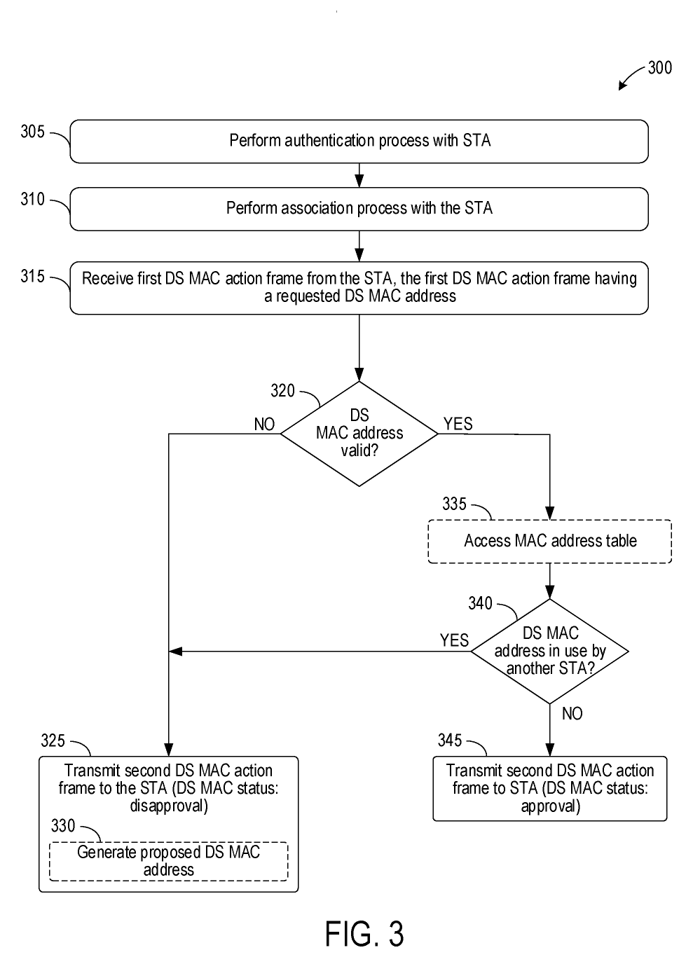

FIG. 3 depicts an example method 300 of coordinating assignment of a DS MAC address to a wireless station using a DS MAC action frame, according to some embodiments of the present disclosure. The method 300 may be used in conjunction with other embodiments, such as being performed by the AP 110 of the wireless communications network 100 of FIG. 1.

The method 300 begins at block 305, where the AP 110 performs an authentication process with the STA 105. In some embodiments, block 305 is performed similar to block 205 of FIG. 2. At block 310, the AP 110 performs an association process with the STA 105. In some embodiments, the association process includes some or all of the blocks of method 200 of FIG. 2. After block 310, the STA 105 may be assumed to have an approved (initial) DS MAC address.

At block 315, the AP 110 receives a first DS MAC action frame from the STA 105, which includes a requested DS MAC address for use by the STA 105 within the DS 113. In some embodiments, the first DS MAC action frame includes a DS MAC IE 138. At block 320, the AP 110 determines whether the requested DS MAC address is valid, e.g., performing processing to determine whether the requested DS MAC address is malformed or otherwise invalid. In some embodiments, block 320 is performed similar to block 215 of FIG. 2.

If the requested DS MAC address is not valid (“NO”), flow proceeds to block 325 and the AP 110 transmits a second DS MAC action frame to the STA 105 that indicates the disapproval of the requested DS MAC address. In some embodiments, the second DS MAC action frame includes a discrete DS MAC status field 168 whose value provides the indication of approval or disapproval, and optionally (at block 330) includes a proposed DS MAC address that is generated by the AP 110.

If the requested DS MAC address is valid (“YES”), flow proceeds to an optional block 335 and the AP 110 accesses a MAC address table (e.g., in its content-addressable memory). At block 340, the AP 110 determines whether the requested DS MAC address is in use by another STA in the DS 113. In some embodiments, this determination is based on the addresses stored in the MAC address table. In some embodiments, this determination is (further) based on querying a device connected to the DS 113, such as a WLC, whether the requested DS MAC address is available. If the requested DS MAC address is in use by another STA (“YES”), flow proceeds to the block 325 and the AP 110 transmits an Association Response frame 145 that indicates the disapproval and optionally a proposed DS MAC address that is generated by the AP 110.

If the requested DS MAC address is not in use by another STA (“NO”), flow proceeds from block 340 to block 345 and the AP 110 transmits the second DS MAC action frame that indicates approval of the requested DS MAC address. The method 300 ends following completion of block 325 or block 345.

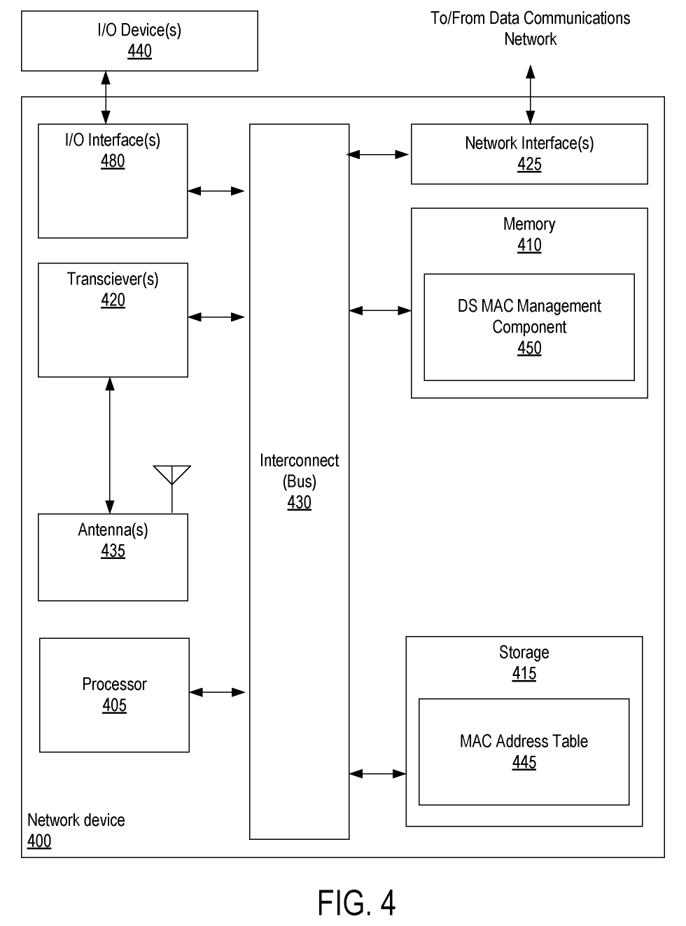

FIG. 4 depicts an example network device 400 configured to perform various aspects of the present disclosure. The network device 400 may represent one example implementation of the AP 110 depicted in FIG. 1.

As illustrated, the example network device 400 includes a processor 405, memory 410, storage 415, one or more transceivers 420, one or more I/O interfaces 480, and one or more network interfaces 425. In some embodiments, I/O devices 440 are connected via the I/O interface(s) 480. Further, via the network interface 425, the network device 400 can be communicatively coupled with one or more other devices and components (e.g., via a network, which may include the Internet, local network(s), and the like). Each of the components is communicatively coupled by one or more buses 430. In some embodiments, one or more antennas 435 may be coupled to the transceivers 420 for transmitting and receiving wireless signals.

The processor 405 is generally representative of a single central processing unit (CPU) and/or graphic processing unit (GPU), multiple CPUs and/or GPUs, a microcontroller, an application-specific integrated circuit (ASIC), or a programmable logic device (PLD), among others. The processor 405 processes information received through the transceiver 420, I/O interfaces 480, and the network interfaces 425. The processor 405 retrieves and executes programming instructions stored in memory 410, as well as stores and retrieves application data residing in storage 415.

The storage 415 may be any combination of disk drives, flash-based storage devices, and the like, and may include fixed and/or removable storage devices, such as fixed disk drives, removable memory cards, caches, optical storage, network attached storage (NAS), or storage area networks (SAN). The storage 415 may store a variety of data for the efficient functioning of the system. In some embodiments, the storage 415 includes a MAC address table 445, e.g., in a content-addressable memory within the storage 415.

The memory 410 may include random access memory (RAM) and read-only memory (ROM). The memory 410 may store processor-executable software code containing instructions that, when executed by the processor 405, enable the network device 400 to perform various functions described herein for wireless communication. In the illustrated example, the memory 410 includes a DS MAC management component 450 as a software component.

In some embodiments, the DS MAC management component 450 parses or otherwise processes wireless frames received from STAs to identify requested DS MAC addresses (e.g., specified in a DS MAC IE 138). In some embodiments, the DS MAC management component 450 performs processing to determine whether the requested DS MAC addresses are malformed or otherwise invalid. In some embodiments, the DS MAC management component 450 determines whether the requested DS MAC addresses are in use within the DS, e.g., by accessing the MAC address table 445 and/or querying another device connected to the DS. In some embodiments, the DS MAC management component 450 provides an indication of approval or disapproval of the requested DS MAC addresses in other wireless frames (e.g., specified in a DS MAC status field 168). In some embodiments, the DS MAC management component 450 generates a proposed DS MAC address for the STA when the indication is disapproval of the STA-requested DS MAC addresses.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the "C" programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method comprising:
establishing a wireless communications link between a first access point and a wireless station;
receiving a first wireless frame on the wireless communications link, the first wireless frame including a requested media access control (MAC) address for use by the wireless station within a distribution system (DS) providing infrastructure that connects a plurality of access points including the first access point;
determining whether the requested MAC address is in use by another wireless station connected to one of the plurality of access points; and
transmitting a second wireless frame on the wireless communications link, the second wireless frame including an indication, based at least in part on whether the requested MAC address is in use, whether use of the requested MAC address by the wireless station is approved.

2. The method of claim 1, wherein establishing the wireless communications link comprises:
assigning the wireless station to an Enhanced Data Privacy (EDP) group that is associated with timing information for rotating wireless frame anonymization parameters at epoch transitions,
wherein the wireless frame anonymization parameters include an over-the-air MAC address used for the wireless station, and
wherein the requested MAC address is used within the DS across a plurality of epochs.

3. The method of claim 1,
wherein the second wireless frame includes a DS MAC status field, and
wherein the indication is a value in the DS MAC status field.

4. The method of claim 3, wherein the second wireless frame further includes a proposed DS MAC address for the wireless station.

5. The method of claim 1, wherein the second wireless frame is one of an Association Response frame and a DS MAC action frame.

6. The method of claim 1, wherein determining whether the requested MAC address is in use by another wireless station comprises:
accessing a MAC address table stored by the first access point.

7. The method of claim 1, wherein determining whether the requested MAC address is in use by another wireless station comprises:
querying a wireless local area network controller connected to the DS.

8. An access point comprising:
one or more processors; and
memory configured to store computer-readable program code which, when executed by any combination of the one or more processors, performs an operation comprising:
establishing a wireless communications link between the access point and a wireless station;
receiving a first wireless frame on the wireless communications link, the first wireless frame including a requested media access control (MAC) address for use by the wireless station within a distribution system (DS) providing infrastructure that connects a plurality of access points including the access point;
determining whether the requested MAC address is in use by another wireless station connected to one of the plurality of access points; and
transmitting a second wireless frame on the wireless communications link, the second wireless frame including an indication, based at least in part on whether the requested MAC address is in use, whether use of the requested MAC address by the wireless station is approved.

9. The access point of claim 8, wherein establishing the wireless communications link comprises:
assigning the wireless station to an Enhanced Data Privacy (EDP) group that is associated with timing information for rotating wireless frame anonymization parameters at epoch transitions,
wherein the wireless frame anonymization parameters include an over-the-air MAC address used for the wireless station, and
wherein the requested MAC address is used within the DS across a plurality of epochs.

10. The access point of claim 8,
wherein the second wireless frame includes a DS MAC status field, and
wherein the indication is a value in the DS MAC status field.

11. The access point of claim 10, wherein the second wireless frame further includes a proposed DS MAC address for the wireless station.

12. The access point of claim 8, wherein the second wireless frame is one of an Association Response frame and a DS MAC action frame.

13. The access point of claim 8, wherein determining whether the requested MAC address is in use by another wireless station comprises:
accessing a MAC address table stored by the access point.

14. The access point of claim 8, wherein determining whether the requested MAC address is in use by another wireless station comprises:
querying a wireless local area network controller connected to the DS.

15. A non-transitory computer-readable storage medium comprising instructions that when executed configure one or more processors of an access point (AP) to perform operations comprising:
establishing a wireless communications link between the access point and a wireless station;
receiving a first wireless frame on the wireless communications link, the first wireless frame including a requested media access control (MAC) address for use by the wireless station within a distribution system (DS) providing infrastructure that connects a plurality of access points including the access point;
determining whether the requested MAC address is in use by another wireless station connected to one of the plurality of access points; and
transmitting a second wireless frame on the wireless communications link, the second wireless frame including an indication, based at least in part on whether the requested MAC address is in use, whether use of the requested MAC address by the wireless station is approved.

16. The non-transitory computer-readable storage medium of claim 15, wherein establishing the wireless communications link comprises:
assigning the wireless station to an Enhanced Data Privacy (EDP) group that is associated with timing information for rotating wireless frame anonymization parameters at epoch transitions,
wherein the wireless frame anonymization parameters include an over-the-air MAC address used for the wireless station, and
wherein the requested MAC address is used within the DS across a plurality of epochs.

17. The non-transitory computer-readable storage medium of claim 15,
wherein the second wireless frame includes a DS MAC status field, and
wherein the indication is a value in the DS MAC status field.

18. The non-transitory computer-readable storage medium of claim 17, wherein the second wireless frame further includes a proposed DS MAC address for the wireless station.

19. The non-transitory computer-readable storage medium of claim 15, wherein the second wireless frame is one of an Association Response frame and a DS MAC action frame.

20. The non-transitory computer-readable storage medium of claim 15, wherein determining whether the requested MAC address is in use by another wireless station comprises one of:
accessing a MAC address table stored by the access point; and
querying a wireless local area network controller connected to the DS.
